(19) United States
(12) Patent Application Publication
(10) Pub. No.: US 2009/0024875 A1
(43) Pub. Date: Jan. 22, 2009

(54) SERIAL ADVANCED TECHNOLOGY ATTACHMENT DEVICE AND METHOD TESTING THE SAME

(76) Inventor: Woo Seong CHEONG, Yongin-si (KR)

Correspondence Address: F. CHAU & ASSOCIATES, LLC, 130 WOODBURY ROAD, WOODBURY, NY, 11797, US

(21) Appl. No.: 12/147,030

(22) Filed: Jun. 26, 2008

(30) Foreign Application Priority Data
Jul. 20, 2007 (KR) 10-2007-0072857

(51) Int. Cl. G06F 11/00; G06F 13/00

(52) U.S. Cl. 714/40; 710/100; 714/E11.02

(57) ABSTRACT

A serial advanced technology attachment (SATA) device is provided. The SATA device includes a digital block and an analog black. The digital block is configured to generate and output an out-of-band (OOB) control signal. The analog block is configured to receive the OOB control signal, which has been output from the digital block, to receive the OOB control signal again after outputting it, and then output the OOB control signal to the digital block.

### CROSS-REFERENCE TO RELATED PATENT APPLICATION

This application claims priority to Korean Patent Application No. 10-2007-0072857, filed on Jul. 20, 2007, in the Korean Intellectual Property Office, the disclosure of which is incorporated by reference in its entirety herein.

### BACKGROUND

1. Technical Field

The present invention relates to an electronic device including a serial advanced technology attachment (SATA) interface, and more particularly, to a SATA device with a self-test function and method of testing the same.

2. Discussion of Related Art

In a serial advanced technology attachment (SATA) interface, out-of-band (OOB) signaling is conducted in several power-on sequence modes for establishing smooth communication links and power saving modes. During the OOB-signaling, signals are transmitted using a pattern of idle signals and burst signals. The physical data rates for SATA are 1.5 Gbps, 3 Gbps, or 6 Gbps.

FIG. 1 schematically illustrates a procedure in which OOB control signals are transmitted between a host platform 20 and a device platform 10 in a conventional SATA device.

Referring to FIG. 1, SATA communication through OOB signaling is initialized as follows. A host controller (not shown) included in the host platform 20 sends a COMRESET signal from a first SATA analog circuit (not shown) included in the host platform 20. The first SATA analog circuit transmits the COMRESET signal to the device platform 10 via a SATA cable as an analog signal.

A device controller (not shown) included in the device platform 10 confirms the COMRESET signal that is received through a second SATA analog circuit (not shown) included in the device platform 10 and transmits a COMINIT signal from the second SATA analog circuit.

The second SATA analog circuit transmits the COMINIT signal to the host platform 20 via the SATA cable as an analog signal. The host controller of the host platform 20 confirms the COMINIT signal received thereto and transmits a COMWAKE signal to the device platform 10. The device controller of the device platform 10 confirms the COMWAKE signal received thereto and transmits the COMWAKE signal to the host platform 20.

The host platform 20 and device platform 10 then exchange an align primitive signal ALIGN to coordinate a communication speed. The device platform 10 and the host platform 20 complete the initialization by generating a standby signal PHY_Ready.

The COMRESET signal is always generated from the host platform 20 and resets the device platform 10. The COMINIT signal is always generated from the device platform 10 and requests an initialization of the communication. The COMINIT signal may be electrically similar to the COMRESET signal. The COMWAKE signal and the align primitive signal ALIGN are generated from the device platform 10 and the host platform 20.

During the testing of OOB signaling, the burst signals, which are generated by the standard SATA specification, need to be applied to a test target to determine whether the OOB signaling has been properly completed. Thus, external test equipment including an analog circuit (e.g., a physical layer) that is able to carry out serial communication with a test target is required.

A SATA device and method of testing the same is disclosed in Korean Patent Application No. 10-2005-0008679, filed by the applicant on Jan. 31, 2005, entitled “SATA Device Having Self-Test Function for OOB Signaling” (hereinafter, referred to as a “prior application”).

FIG. 2 is a schematic block diagram of a SATA device 100 disclosed in the prior application. The SATA device 100 includes a SATA analog signal processor 131, a SATA controller 120, and an application system 110. The SATA controller 120 forms data transferred from the application system 110 into data packets and transmits the data packets through the analog signal processor 131, or abstracts data in data packets transferred from the analog signal processor 131 and transmits the abstracted data to the application system 110.

The analog signal processor 131 generates analog signals in compliance with the SATA controller 120 and then transmits the analog signals to an external device, or receives analog signals from an external device and then transfers the received analog signals to the SATA controller 120 after signal processing such as a noise removing process.

The SATA controller 120 includes a target OOB-signaling controller 122, a test flow controller 123, a test-signaling controller 124, and a link/transmission unit 121. The SATA device 100 includes a control block (i.e., the target OOB-signaling controller 122 or the test-signaling controller 124), which are respectively included in a test platform (e.g., a host platform) and a target platform (e.g., a device platform). A separate control block (i.e., the test flow controller 123) is required to control the control blocks and perform diagnostic tests. Accordingly, testing of OOB signaling using the SATA device 200 requires additional space and has a higher cost.

Thus, there is a need for a SATA device that enables OOB signaling in less space and/or at a lower cost.

### SUMMARY OF THE INVENTION

According to an exemplary embodiment of the present invention, a method of testing a SATA device includes outputting an OOB control signal using the SATA device and receiving the OOB control signal, which has been output, using the SATA device.

The OOB control signal may include at least one of a COMRESET signal, a COMINIT signal, a COMWAKE signal, and an align primitive signal. The method may further include outputting an error signal when the SATA device does not receive the OOB control signal within a predetermined period of time.

The SATA device may include a loopback circuit to receive the OOB control signal that is output from the SATA device. The SATA device may further include a state machine. A state in the state machine where the OOB control signal is output may be the same as a state in the state machine when the OOB control signal is received. Alternatively, the state in which the OOB control signal is received is a next state following the state in which the OOB control signal is output. The SATA device may include at least one of a computer, a hard disk drive, or a solid state disk.

According to an exemplary embodiment of the present invention a method of testing a SATA device includes outputting a COMINIT signal using the SATA device, and receiving the COMINIT signal, which has been output, using the SATA device.

The method may further include outputting a COMWAKE signal using the SATA device, and receiving the COMWAKE signal, which has been output, using the SATA device. The method may further include outputting an align primitive signal using the SATA device, and receiving the align primitive signal, which has been output, using the SATA device. The method may further include generating a standby signal when the SATA device receives the align primitive signal, which has been output by the SATA device.

According to an exemplary embodiment of the present invention, a SATA device includes a digital block and analog block. The digital block is configured to generate and output an OOB control signal. The analog block is configured to receive the OOB control signal output from the digital block, receive the OOB control signal again after outputting it, and then output the OOB control signal to the digital block. The digital block may output an error signal when the digital block does not receive the OOB control signal returned by the analog block within a predetermined period of time.

The analog block may include a loopback circuit to receive the OOB control signal that has been output by the analog block. The digital block may include a state machine. A state in the state machine when the digital block outputs the OOB control signal may be the same as a state in the state machine when the digital block receives the OOB signal from the analog block. Alternatively, the state when the digital block receives the OOB control signal from the analog block may be a next state following the state when the digital block outputs the OOB signal.

### BRIEF DESCRIPTION OF THE DRAWINGS

The present invention will become more apparent by describing in detail exemplary embodiments thereof with reference to the attached drawings in which:

FIG. 1 schematically illustrates a process of transmitting out-of-band (OOB) control signals between a host platform and a device platform in a conventional serial advanced technology attachment (SATA) device;

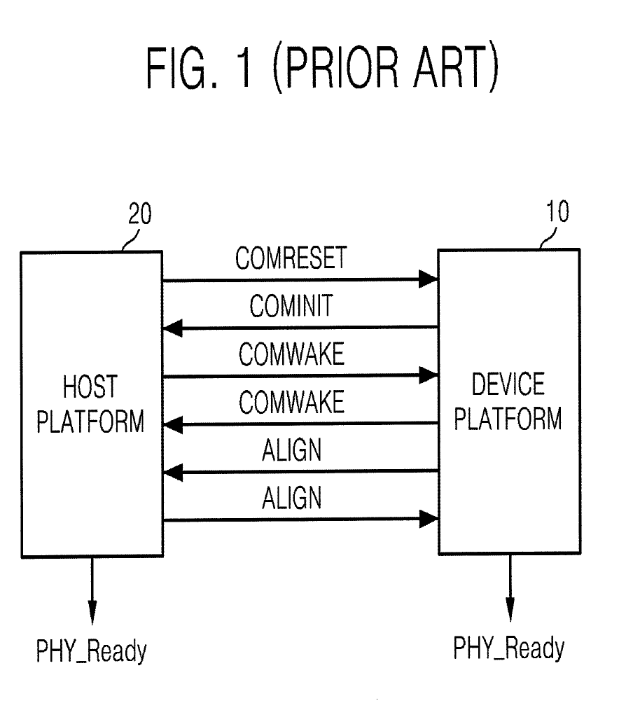

FIG. 2 is a schematic block diagram of a conventional SATA device;

FIG. 3 is a schematic block diagram of a SATA device according to an exemplary embodiment of the present invention;

FIG. 4 is a state diagram illustrating a conventional method of testing a SATA device;

FIG. 5 is a state diagram illustrating a method of testing a SATA device according to an exemplary embodiment of the present invention; and

FIG. 6 is a state diagram illustrating a method of testing a SATA device according to an exemplary embodiment of the present invention.

### DETAILED DESCRIPTION OF EXEMPLARY EMBODIMENTS

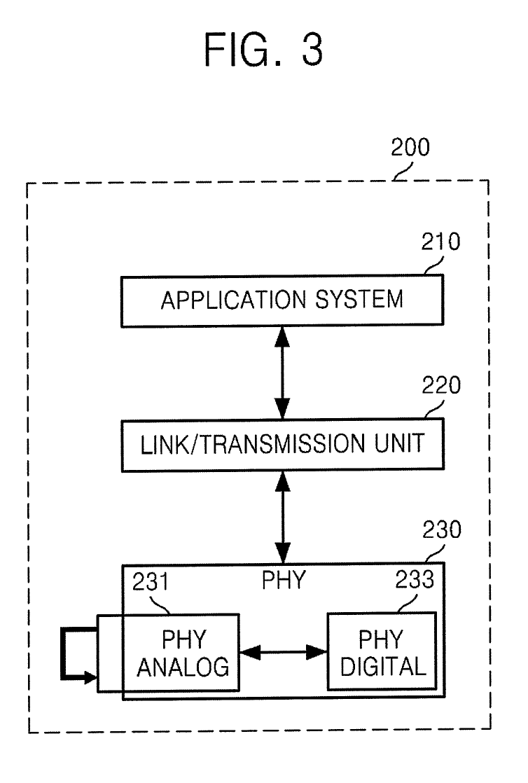

FIG. 3 is a schematic block diagram of a serial advanced technology attachment (SATA) device 200 according to an exemplary embodiment of the present invention. Referring to FIG. 3, a physical (PHY) layer 230 of the SATA device 200 includes an analog block 231 and a digital block 233. The SATA device 200 may further include an application system 210 and a link/transmission unit 220.

The PHY layer 230 of the SATA device 200 includes the analog block 231 and the digital block 233. The PHY layer 230 may be defined by standards that include SATA standards. However, unlike the SATA standards, out-of-band (OOB) signaling of the SATA device 200 can be tested by testing the link between the digital block 233 and the analog block 231 using the same signal.

For example, the digital block 233 may generate and output an OOB control signal. The digital block 233 may include a predetermined control module (not shown) to test OOB signaling and the control module may include a state machine. The OOB control signal may include at least one of the control signals defined by the SATA standards, such as a COMRESET signal, a COMINIT signal, a COMWAKE signal, and an align primitive signal ALIGN.

The SATA device 200 may be an information processing device such as a desktop or laptop computer having a device platform, a hard disk drive, or a solid state disk, which can communicate with the information processing device through a SATA interface.

The analog block 231 receives the OOB control signal, receives the OOB control signal again after outputting the received OOB control signal, and outputs the OOB signal to the digital block 233. For example, when the SATA device 200 is implemented in a device platform, the digital block 233 may generate the COMINIT signal and output it to the analog block 231. The analog block 231 may output an analog signal corresponding to the COMINIT signal. In conventional test methods, the analog block 231 outputs the analog signal corresponding to the COMINIT signal to a test unit separately provided for a host.

However, according to an exemplary embodiment of the present invention, the analog block 231 again receives the analog signal corresponding to the COMINIT signal, which has been output, without using a separate test unit to generate a self-test function. The analog block 231 may include a circuit such as a loopback circuit or a feedback circuit to feed or loop the signal output by the analog block 231 back to itself.

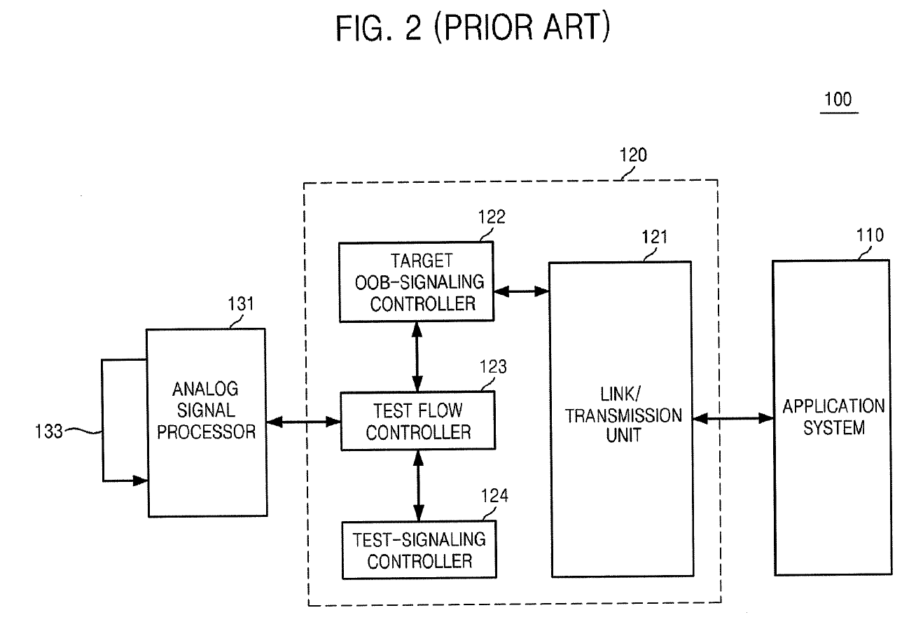

According to the SATA standards, after outputting the analog signal corresponding to the COMINIT signal, the device platform receives the COMWAKE signal from a host platform, as illustrated in FIG. 2.

However, the analog block 231 outputs the COMINIT signal and then receives the COMINIT signal again. Since the COMINIT signal is electrically similar to the COMWAKE signal, confirming whether the COMINIT signal output from the digital block 233 can be received by the digital block 233 via the analog block 231 is enough to test the link between the digital block 233 and the analog block 231, which are included in the PHY layer 230 of the SATA device 200.

A method of transmitting the COMINIT signal from the device platform to the host platform and the COMWAKE signal from the host platform to the device platform in the SATA standards may correspond to a method in which the COMINIT signal output from the digital block 233 is fed or looped back to the digital block 233 via the analog block 231.

A method of testing the SATA device 200 according to an exemplary embodiment of the present invention includes confirming whether an OOB control signal can be received by a source after being output from the source. The COMWAKE signal and/or the align primitive signal ALIGN may be used in the same manner as the COMINIT signal is used to carry out the test.

The digital block 233 may output an error signal when it does not receive the OOB control signal (e.g., the COMINIT signal, the COMWAKE signal, or the align primitive signal ALIGN) from the analog block 231 within a predetermined period of time. A state machine representative of the testing method may be included in the digital block 233.

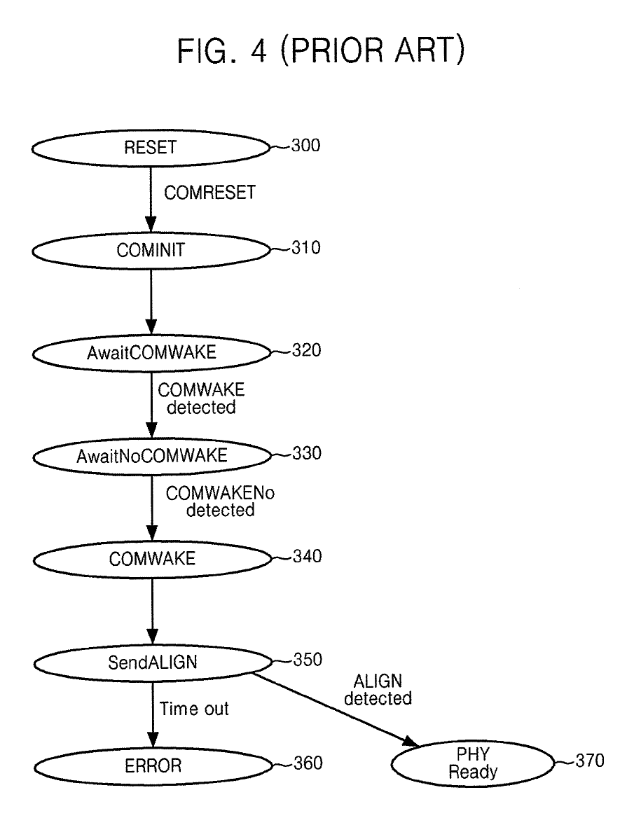

FIG. 4 is a state diagram illustrating a conventional method of testing a SATA device, where the SATA device is a device platform. Referring to FIG. 4, the SATA device in a RESET state 300 enters a COMINIT state 310 when a COMRESET signal is received. In the COMINIT state 310, the SATA device outputs a COMINIT signal and immediately enters an AwaitCOMWAKE state 320.

When the SATA device detects or receives a COMWAKE signal in the AwaitCOMWAKE state 320, the SATA device enters an AwaitNoCOMWAKE state 330. The AwaitNoCOMWAKE state 330 may be a state via which the SATA device can selectively enter a calibrate state or a COMWAKE state 340, which is defined by the SATA standards. In another embodiment of the present invention, the SATA device does not enter the calibrate state.

When the COMWAKE signal is no longer detected in the AwaitNoCOMWAKE state 330, the SATA device enters the COMWAKE state 340. When entering the COMWAKE state 340, the SATA device outputs the COMWAKE signal and immediately enters a SendALIGN state 350.

In the SendALIGN state 350, the SATA device outputs an align primitive signal ALIGN. However, if the align primitive signal ALIGN is not received within a predetermined period of time thereafter, the SATA device enters an ERROR state 360 and outputs an error signal. As defined by the SATA standards, if the align primitive signal ALIGN is not received within the predetermined period of time in the SendALIGN state 350, the SATA device lowers a communication speed and re-enters the SendALIGN state 350.

In an exemplary embodiment of the present invention, the ERROR state 360 may indicate a state in which an align primitive signal ALIGN is not received within the predetermined period of time when the communication speed cannot be lowered any further.

When the align primitive signal ALIGN is detected or received within the predetermined period of time in the SendALIGN state 350, the SATA device enters a PHYReady state 370 and outputs a standby signal PHY_Ready or a sink signal corresponding to the standby signal PHY_Ready.

However, a state machine according to an exemplary embodiment of the present invention can carry out the test by confirming whether a signal output from a platform can be received in its current form.

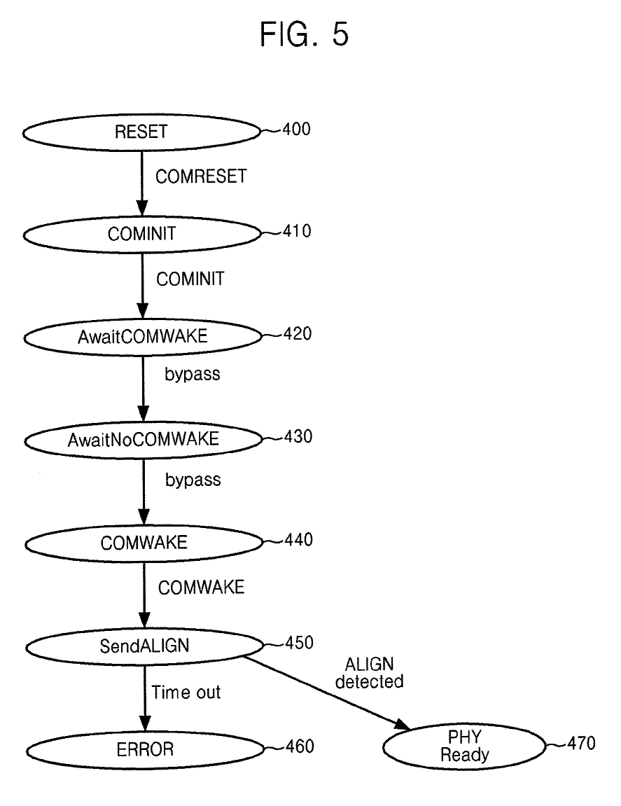

FIG. 5 is a state diagram illustrating a method of testing a SATA device according to an exemplary embodiment of the present invention, where the SATA device is a device platform.

Referring to FIG. 5, the SATA device enters a COMINIT state 410 when receiving a COMRESET signal in a RESET state 400. In the COMINIT state 410, the SATA device outputs a COMINIT signal and enters an AwaitCOMWAKE state 420 when the COMINIT signal, which has been output, is received. For example, when the SATA device receives the COMINIT signal that the SATA device has output in the COMINIT state 410, the SATA device enters a next state. When the SATA device does not receive the COMINIT signal within a predetermined period of time in the COMINIT state 410, the SATA device may immediately enter an ERROR state 460 and output an error signal.

After entering the AwaitCOMWAKE state 420, the SATA device bypasses the AwaitCOMWAKE state 420 and a next AwaitNoCOMWAKE state 430. Here, when the SATA device “bypasses” a state, it means that the SATA device unconditionally enters a next state.

After entering a COMWAKE state 440, the SATA device outputs a COMWAKE signal. Thereafter, when receiving the COMWAKE signal that has been output, the SATA device enters a SendALIGN state 450. When the SATA device does not receive the COMWAKE signal within a predetermined period of time in the COMWAKE state 440, the SATA device immediately enters the ERROR state 460 and outputs an error signal.

When the SATA device does not receives an align primitive signal ALIGN within a predetermined period of time in the SendALIGN state 450, the SATA device enters the ERROR state 460 and outputs the error signal. Alternately, when the align primitive signal ALIGN is not received within the predetermined period of time in the SendALIGN state 450, the SATA device may lower a communication speed and re-enter the SendALIGN state 450. When the align primitive signal ALIGN is received within the predetermined period of time in the SendALIGN state 450, the SATA device enters a PHYReady state 470.

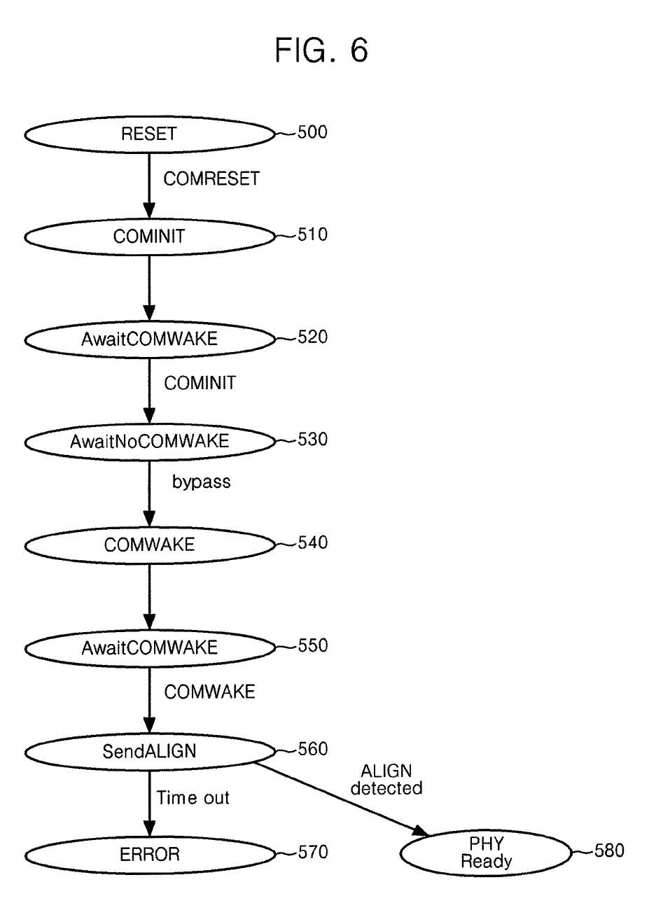

While embodiments of the present invention have been described with reference to FIG. 5 and a device platform, the present invention may also be applied to a host platform. A SATA device according to an exemplary embodiment of the present invention may be implemented by a host platform by implementing a state machine similar to the illustrated in FIG. 5. For example, the OOB control signals, i.e., the COMINIT signal, the COMWAKE signal, and the align primitive signal ALIGN that are output from the device platform may be replaced with OOB control signals, i.e., a COMRESET signal, a COMWAKE signal, and an align primitive signal ALIGN that are output from the host platform. While, the SATA device enters a next state when it receives an OOB control signal that has been output in a current state in an embodiment described with reference to FIG. 5, the SATA device may receive the OOB control signal after outputting the OOB control signal and entering the next state in an alternate embodiment of the present invention, which is illustrated in FIG. 6.

FIG. 6 is a state diagram illustrating a method of testing a SATA device according to an exemplary embodiment of the present invention. While, the SATA device is also a device platform, a representative state diagram can be inferred from the state diagram illustrated in FIG. 6 when the SATA device is a host platform.

Referring to FIG. 6, the SATA device enters a COMINIT state 510 when a COMRESET signal is received in a RESET state 500. The SATA device outputs a COMINIT signal in the COMINIT state 510 and then enters a first AwaitCOMWAKE state 520. When the COMINIT signal that has been output from the SATA device has been received in the first AwaitCOMWAKE state 520, the SATA device enters an AwaitNoCOMWAKE state 530.

Unlike the state diagram illustrated in FIG. 5, the SATA device receives an OOB control signal, which is output by the SATA device in a current state, in a subsequent state according to the state diagram illustrated in FIG. 6. The names of states illustrated in FIG. 6 are used for the sake of convenience to correspond to the states illustrated in FIG. 5. The names may vary without restricting the scope of the present invention.

When the SATA device does not receive the COMINIT signal within a predetermined period of time in the first AwaitCOMWAKE state 520, the SATA device may immediately enter an ERROR state 570 and output an error signal. When receiving the COMINIT signal in the first AwaitCOMWAKE state 520, the SATA device bypasses the AwaitNoCOMWAKE state 530 and enters a COMWAKE state 540.

After outputting a COMWAKE signal in the COMWAKE state 540, the SATA device enters a second AwaitCOMWAKE state 550. When receiving the COMWAKE signal in the second AwaitCOMWAKE state 550, the SATA device enters a SendALIGN state 560. When the SATA device does not receive the COMWAKE signal within a predetermined period of time in the second AwaitCOMWAKE state 550, it may immediately enter the ERROR state 570 and output an error signal.

When the SATA device does not receive an align primitive signal ALIGN within a predetermined period of time in the SendALIGN state 560, it enters the ERROR state 570 and outputs an error signal. Alternately, when the align primitive signal ALIGN is not received within the predetermined period of time in the SendALIGN state 560, the SATA device may lower a communication speed and re-enter the SendALIGN state 560. When the align primitive signal ALIGN is received within the predetermined period of time in the SendALIGN state 560, the SATA device enters a PHYReady state 580.

According to at least one embodiment of the present invention, a SATA device can perform a self-test in less space and at a lower cost, since additional test equipment is not required. Further, at least one embodiment of the present invention can be used with either a host platform or a device platform.

While the present invention has been particularly shown and described with reference to exemplary embodiments thereof, it will be understood by those of ordinary skill in the art that various changes in form and details may be made therein without departing from the spirit and scope of the present invention.

What is claimed is:

1. A method of testing a serial advanced technology attachment (SATA) device, the method comprising:
outputting an out-of-band (OOB) control signal using the SATA device; and
receiving the OOB control signal, which has been output, using the SATA device.

2. The method of claim 1, wherein the OOB control signal comprises at least one of a COMRESET signal, a COMINIT signal, a COMWAKE signal, and an align primitive signal.

3. The method of claim 1, further comprising outputting an error signal when the SATA device does not receive the OOB control signal within a predetermined period of time.

4. The method of claim 1, wherein the SATA device comprises a loopback circuit to receive the OOB control signal that is output from the SATA device.

5. The method of claim 1, wherein the SATA device comprises a state machine and a state in which the OOB control signal is output is the same as a state in which the OOB control signal is received.

6. The method of claim 1, wherein the SATA device comprises a state machine and a state in which the OOB control signal is received is a next state following a state in which the OOB control signal is output.

7. The method of claim 1, wherein the SATA device comprises at least one of a computer, a hard disk drive, or a solid state disk.

8. A method of testing a serial advanced technology attachment (SATA) device, the method comprising:
outputting a COMINIT signal using the SATA device; and
receiving the COMINIT signal, which has been output, using the SATA device.

9. The method of claim 8, further comprising:
outputting a COMWAKE signal using the SATA device; and
receiving the COMWAKE signal, which has been output, using the SATA device.

10. The method of claim 9, further comprising:
outputting an align primitive signal using the SATA device; and
receiving the align primitive signal, which has been output, using the SATA device.

11. The method of claim 10, further comprising generating a standby signal when the SATA device receives the align primitive signal, which has been output by the SATA device.

12. A serial advanced technology attachment (SATA) device comprising:
a digital block configured to generate and output an out-of-band (OOB) control signal; and
an analog block configured to receive the OOB control signal output from the digital block, receive the OOB control signal again after outputting it, and then output the OOB control signal to the digital block.

13. The SATA device of claim 12, wherein the digital block outputs an error signal when the digital block does not receive the OOB control signal returned by the analog block within a predetermined period of time.

14. The SATA device of claim 12, wherein the analog block comprises a loopback circuit to receive the OOB control signal that has been output by the analog block.

15. The SATA device of claim 12, wherein the digital block comprises a state machine, and a state in the state machine when the digital block outputs the OOB control signal is the same as a state in the state machine when the digital block receives the OOB signal from the analog block.

16. The SATA device of claim 12, wherein the digital block comprises a state machine, and a state in the state machine when the digital block receives the OOB control signal from the analog block is a next state following a state in the state machine when the digital block outputs the OOB signal.
